(19) United States
(12) Patent Application Publication
(10) Pub. No.: US 2026/0217972 A1
(43) Pub. Date: Jul. 30, 2026

(54) COMPOSITION COMPRISING AT LEAST ONE RECYCLED ALIPHATIC POLYAMIDE

(71) Applicant: ARKEMA FRANCE, Puteaux (FR)

(72) Inventor: Thomas PRENVEILLE, Serquigny (FR)

(73) Assignee: ARKEMA FRANCE, Puteaux (FR)

(21) Appl. No.: 19/147,248

(22) PCT Filed: Jan. 11, 2024
(86) PCT No.: PCT/FR2024/050036

§ 371 Date: Jul. 10, 2025

(30) Foreign Application Priority Data
Jan. 11, 2023 (FR) FR2300266

(51) Int. Cl. C08L 77/02; B29B 17/04; B29K 77/00; B29K 105/26

(52) U.S. Cl. CPC C08L 77/02; B29B 17/0412; B29K 2077/00; B29K 2105/26; C08L 2203/30; C08L 2205/02; C08L 2205/06; C08L 2207/20

(57) ABSTRACT

The present invention relates to a composition comprising at least:
(a) from 30% to 99.9% by weight of at least one recycled aliphatic polyamide,
(b) from 0.1% to 10% by weight of at least one additive,
(c) from 0% to 70% by weight of at least one virgin polyamide,
(d) from 0% to 65% by weight of at least one filler,
(e) from 0% to 15% by weight of at least one plasticizer,
(f) from 0% to 30% by weight of at least one impact modifier.

It also relates to the use of such a composition for the manufacture of objects, and to the corresponding objects.

The present patent application relates to a composition comprising at least one recycled aliphatic polyamide and to a process for its manufacture.

It also relates to the use of such a composition for the manufacture of objects, and to the corresponding objects.

Through a circular economy it is possible to limit waste generation, depletion of the planet's resources, and environmental impact. In this context, it is desired in particular to promote the (energy or material) upgrading and in particular the recycling of waste. This makes it possible to thus limit as much as possible the ultimate waste, that is to say the waste which is not capable of being processed under current technical and economic conditions and which will be incinerated or sent to specific storage centers.

The term “energy upgrading” is understood to denote the use of waste (oils, tires, plastics, and the like) as means for the production of energy, by direct incineration, with or without other waste.

The term “material upgrading” is understood to denote the reuse or the re-employment, that is to say the fresh employment, of a part which retains the same use and is not transformed.

The term “recycling” is understood to denote the operation targeted at introducing the materials originating from waste into the production cycle, in complete or partial replacement of a virgin material.

The present invention relates very particularly to the recycling of waste, and is notably directed toward providing compositions comprising at least one recycled aliphatic polyamide.

There typically exist two types of recycled content: post-industrial (or post-industrial recycled: PIR) waste and post-consumer (or post-consumer recycled: PCR) waste.

Post-industrial waste (also known as “pre-consumer” waste) refers to the waste generated either by the manufacturing process which resulted in the creation of the original source material (manufacturing process of polymerization and/or compounding type, for example) or by the manufacturing process which resulted, starting in particular from an original source material, in the creation of an object, such as a sports article, an article for a motor vehicle, such as, for example, an airplane, a drone, an aircraft, an electric bicycle, a moped, a motorcycle, a side car, a car, a van, a tractor, a truck, a bus, a coach, a snowmobile, a motor crawler, a bulldozer, a snow groomer and a tank, an electronic article for the general public, a medical article or an industrial article (manufacturing process of injection molding or extrusion type, for example). Post-industrial waste within the meaning of the invention can thus typically be injection sprues of these various articles or purge blocks. Within the meaning of the invention, parts which fail to meet the specifications or which have defects of such a nature as to prevent them from being sold are also regarded as post-industrial waste.

Post-consumer waste, for its part, corresponds to articles, such as, for example, those mentioned above, after use by the final consumer or which have reached the end of their life. This is waste which has been used before being discarded, for example which has been used for at least a day, for example at least a week, for example at least a month, for example at least a year, for example several years. This waste is typically collected from the end users during the discarding thereof, for the purpose of recycling it.

Nowadays, the management of waste (both post-industrial and post-consumer) and also the lifespan of an object are essential for the consumer and have become key requirements, in particular for major sports and electronics brands. This trend increases the advantage of having available compositions containing, at least in part, recycled products.

Also, in the context of sustainable consumption and production modes, the quality of the recycled products used in frequently replaced objects, such as sports articles and electronic articles for the general public, takes on particular importance. In point of fact, for these articles, the requirements in terms of performance are particularly high.

For these reasons, there is thus a need to have available compositions comprising at least one aliphatic polyamide and having a much smaller impact on CO2 emissions.

There is also a need for novel compositions comprising at least one recycled aliphatic polyamide which retains good mechanical properties (for example in terms of impact strength, low density, modulus, elongation at break, breaking strength and ability to adhere to different substrates) and also good processability (suitability for processing, for transformation, notably by extrusion, injection, overmolding, or welding). In particular, there remains a need for compositions having improved processability by injection molding, notably a long injection flow length.

The objects obtained from the compositions according to the invention advantageously have properties sufficient to enable them to be used in high performance applications and not only in lower performance applications, such as in street furniture or roads.

In particular, the compositions according to the invention advantageously have better processability and notably an increase in the flow length during injection molding. This improvement makes it possible to injection mold thinner parts with better definition.

The compositions according to the invention can also make possible better adhesion to other polymers and in particular to polyamides.

The compositions according to the invention may also have a lower elongation at break and a lower tensile strength, compared with compositions not comprising a recycled aliphatic polyamide of the invention.

The compositions of the invention can thus be advantageously used for applications concerning safety parts, in particular for the manufacture of parts designed to yield under a certain stress (for instance emergency stop devices or fire alarm devices). In fact, it may advantageously be easier to control the rupture of a part under elongation or force (if necessary by using a kind of notch or a point of weakness to locate the rupture) by using a composition of the invention.

The inventors have discovered, surprisingly, that the use of recycled aliphatic polyamides as defined below, in compositions according to the invention, makes it possible to meet these needs.

Thus, the invention relates, according to one of its aspects, to a composition comprising at least:
(a) from 30% to 99.9% by weight of at least one recycled aliphatic polyamide having functions resulting from oxidation reactions chosen from primary amide functions, nitriles, chain-end methyl groups, alkenes, formamides, imides, carboxylic acids, alcohols and mixtures thereof in a mole ratio, relative to the secondary amide functions, which is greater than that of the same virgin aliphatic polyamide and/or of at least one recycled aliphatic polyamide having primary amine functions in a mole ratio, relative to the secondary amide functions, which is lower than that of the same virgin aliphatic polyamide,
(b) from 0.1% to 10% by weight of at least one additive,
(c) from 0% to 70% by weight of at least one virgin polyamide,
(d) from 0% to 65% by weight of at least one filler,
(e) from 0% to 15% by weight of at least one plasticizer,
(f) from 0% to 30% by weight of at least one impact modifier.

The invention also relates, according to another of its aspects, to the use of a composition in accordance with the invention for giving said composition a longer injection flow length relative to the same composition in which the aliphatic polyamide is not recycled.

The invention also relates to the use of 30% to 99.9% by weight of at least one recycled aliphatic polyamide as defined according to the invention in a composition as defined according to the invention, to give said composition a longer injection flow length relative to the same composition in which the aliphatic polyamide is not recycled.

The invention also relates, according to another of its aspects, to the use of a composition in accordance with the invention for manufacturing objects, in particular mono-material objects.

The invention also relates, according to another of its aspects, to an object, in particular a mono-material object, consisting of at least 30% by weight, preferably at least 50% by weight, of a composition in accordance with the invention.

### Recycled Aliphatic Polyamide

The recycled aliphatic polyamide according to the invention contains functions resulting from oxidation reactions chosen from primary amide functions, nitriles, chain-end methyl groups, alkenes, formamides, imides, carboxylic acids, alcohols and mixtures thereof in a mole ratio, relative to the secondary amide functions, which is greater than that of the same virgin aliphatic polyamide.

Alternatively or additionally, the recycled aliphatic polyamide according to the invention contains primary amine functions in a mole ratio, relative to the secondary amide functions, which is lower than that of the same virgin aliphatic polyamide.

According to one embodiment, a composition of the invention comprises from 30% to 99.9% by weight of at least one recycled aliphatic polyamide containing functions resulting from oxidation reactions chosen from primary amide functions, nitriles, chain-end methyl groups, alkenes, formamides, imides, carboxylic acids, alcohols and mixtures thereof in a mole ratio, relative to the secondary amide functions, which is greater than that of the same virgin aliphatic polyamide. According to this embodiment, said recycled aliphatic polyamide may not contain primary amine functions in a mole ratio, relative to the secondary amide functions, which is lower than that of the same virgin aliphatic polyamide.

According to another embodiment, a composition of the invention comprises from 30% to 99.9% by weight of at least one recycled aliphatic polyamide containing primary amine functions in a mole ratio, relative to the secondary amide functions, which is lower than that of the same virgin aliphatic polyamide. According to this embodiment, it is possible that said recycled aliphatic polyamide does not contain functions resulting from oxidation reactions chosen from primary amide functions, nitriles, chain-end methyl groups, alkenes, formamides, imides, carboxylic acids, alcohols and mixtures thereof in a mole ratio, relative to the secondary amide functions, which is greater than that of the same virgin aliphatic polyamide.

According to yet another embodiment, a composition of the invention comprises from 30% to 99.9% by weight of at least one recycled aliphatic polyamide containing functions resulting from oxidation reactions chosen from primary amide functions, nitriles, chain-end methyl groups, alkenes, formamides, imides, carboxylic acids, alcohols and mixtures thereof in a mole ratio, relative to the secondary amide functions, which is greater than that of the same virgin aliphatic polyamide and of at least one recycled aliphatic polyamide containing primary amine functions in a mole ratio, relative to the secondary amide functions, which is lower than that of the same virgin aliphatic polyamide.

According to this embodiment, a composition of the invention can comprise at least two different recycled aliphatic polyamides, namely a first recycled aliphatic polyamide containing functions resulting from oxidation reactions chosen from primary amide functions, nitriles, chain-end methyl groups, alkenes, formamides, imides, carboxylic acids, alcohols and mixtures thereof in a mole ratio, relative to the secondary amide functions, which is greater than that of the same virgin aliphatic polyamide and a second recycled aliphatic polyamide, which is different from said first recycled aliphatic polyamide containing primary amine functions in a mole ratio, relative to the secondary amide functions, which is lower than that of the same virgin aliphatic polyamide.

Alternatively, and preferably, it can concern one and the same aliphatic polyamide containing both (i) functions resulting from oxidation reactions chosen from primary amide functions, nitriles, chain-end methyl groups, alkenes, formamides, imides, carboxylic acids, alcohols and mixtures thereof in a mole ratio, relative to the secondary amide functions, which is greater than that of the same virgin aliphatic polyamide and (ii) primary amine functions in a mole ratio, relative to the secondary amide functions, which is lower than that of the same virgin aliphatic polyamide.

According to one embodiment, the recycled aliphatic polyamide more particularly comprises functions resulting from oxidation reactions chosen from nitriles and chain-end methyl groups in a mole ratio relative to secondary amide functions which is higher than that of the same virgin aliphatic polyamide.

According to the invention, the mole ratio of at least one of the functions resulting from oxidation reactions as defined previously relative to the secondary amide functions, can be greater for the recycled aliphatic polyamide of the invention, in comparison with said mole ratio for the same virgin aliphatic polyamide.

This means that on measuring, on the one hand, the molar amount of one of the functions resulting from oxidation reactions as defined previously and, on the other hand, the molar amount of the secondary amide functions in the recycled aliphatic polyamide of the invention, and that on determining the ratio between these two molar amounts (so as to obtain the mole ratio of said function resulting from oxidation reactions relative to the secondary amide functions for the recycled aliphatic polyamide), said ratio will be greater than that calculated for the same virgin aliphatic polyamide (that is to say greater than the ratio between, on the one hand, the molar amount of one of the functions resulting from oxidation reactions as defined previously and, on the other hand, the molar amount of the secondary amide functions in the same virgin aliphatic polyamide).

In particular, according to the invention, the functions resulting from oxidation reactions may be present in the recycled aliphatic polyamide of the invention in a mole ratio relative to the secondary amide functions greater by at least 10%, for example greater by at least 100%, for example greater by at least 150%, for example greater by at least 300% relative to that of the same virgin aliphatic polyamide.

The molar amounts of the functions resulting from oxidation reactions and the molar amounts of the secondary amide functions (and consequently the mole ratio between these two amounts) can notably be measured by NMR, for example by proton NMR, in particular according to the conditions described below.

According to the invention, the mole ratio of the primary amine functions relative to the secondary amide functions, can be lower for the recycled aliphatic polyamide of the invention, in comparison with said mole ratio for the same virgin aliphatic polyamide.

Similarly to that which was set out previously, this means that on measuring, on the one hand, the molar amount of the primary amine functions and, on the other hand, the molar amount of the secondary amide functions in the recycled aliphatic polyamide of the invention and on determining the ratio between these two molar amounts (so as to obtain the mole ratio of the primary amine functions relative to the secondary amide functions, for the recycled aliphatic polyamide), said ratio will be lower than that calculated for the same virgin aliphatic polyamide (that is to say, lower than the ratio between, on the one hand, the molar amount of the primary amine functions and, on the other hand, the molar amount of the secondary amide functions in the same virgin aliphatic polyamide).

In particular, according to the invention, the primary amine functions can be present in the recycled aliphatic polyamide of the invention in a mole ratio, relative to the secondary amide functions, which is lower by at least 10%, for example lower by at least 50%, for example lower by at least 100%, for example lower by at least 150%, relative to that of the same virgin aliphatic polyamide.

The molar amounts of the primary amine functions and the molar amounts of the secondary amide functions (and consequently the mole ratio between these two amounts) can notably be measured by NMR, for example by proton NMR, in particular according to the conditions described below.

The compositions of the invention comprise from 30% to 99.9% by weight of at least one recycled aliphatic polyamide, relative to the total weight of said composition.

According to one embodiment, the compositions of the invention may comprise from 50% to 99.5% by weight of recycled aliphatic polyamide, relative to the total weight of the composition, for example from 70% to 99% by weight, for example from 80% to 98.5% by weight.

As indicated previously, the aliphatic polyamide used in the compositions according to the invention is recycled.

The term “recycled aliphatic polyamide” is understood to denote, for the purposes of the invention, an aliphatic polyamide resulting from post-industrial waste and/or post-consumer waste, as defined previously.

More precisely, in the context of the present invention, the term “post-industrial waste” means waste generated either by the manufacturing process that led to the creation of the original source material, or by the manufacturing process that led, starting notably from an original source material, to the creation of an object as defined previously, said waste having been recycled at least once, preferably at least twice, notably more than twice.

According to one embodiment, the recycled aliphatic polyamide used in the compositions of the invention may notably result from post-industrial waste as defined previously, which can be recovered, for example, after a manufacturing step leading to the creation of the original source material or after a manufacturing step leading, starting notably from an original source material, to the creation of an object such as a sports article, an article for a motor vehicle, for instance an airplane, a drone, an aircraft, an electric bicycle, a moped, a motorcycle, a sidecar, a car, a van, a tractor, a truck, a bus, a coach, a snowmobile, a half-track, a bulldozer, a snow groomer and a tank, an electronic article for the general public, a medical article or an industrial article, and which has been recycled at least once, preferably at least twice, notably more than twice. It may notably comprise scrap which has been processed in the melt, i.e. at a temperature greater than its melting temperature (preferably at a temperature greater by at least 20° C., for example by at least 30° C., for example by at least 40° C., for example by at least 50° C. than its melting temperature). Preferably, this scrap originates from extrusion or injection molding processes and has been recycled at least once, preferably at least twice, notably more than twice. It may also be articles of poor quality or those unsuitable for their function, which are also considered waste, provided they have been recycled at least once, preferably at least twice, notably more than twice. This waste is thereafter generally ground to be used in a composition of the invention.

According to another embodiment, the recycled aliphatic polyamide used in the compositions of the invention may notably result from post-consumer waste. It may notably be sports articles, articles for a motor vehicle, for instance an airplane, a drone, an aircraft, an electric bicycle, a moped, a motorcycle, a sidecar, a car, a van, a tractor, a truck, a bus, a coach, a snowmobile, a half-track, a bulldozer, a snow groomer and a tank, used electronic articles for the general public, used medical articles and/or used industrial articles which are recovered after purchase and use, preferably repeated use, by the end consumer, or when they have reached the end of their life. The expression “used” denotes an article which is no longer new, has already fulfilled its use or has already been used. This expression does not in any case cover post-consumer or post-industrial waste that is recycled without having fulfilled its use or without having been used.

According to yet another embodiment, the recycled aliphatic polyamide used in the compositions of the invention may result from a mixture of post-industrial waste and post-consumer waste as defined above. For example, post-industrial waste can be mixed with post-consumer waste such as used sports articles, articles for a motor vehicle such as, for example, an airplane, a drone, an aircraft, an electric bicycle, a moped, a motorcycle, a sidecar, a car, a van, a tractor, a truck, a bus, a coach, a snowmobile, a half-track, a bulldozer, a snow groomer and a tank, used electronic articles for the general public, used medical articles and/or used industrial articles that are also subsequently ground.

In one particular embodiment of the invention, the expression “recycled aliphatic polyamide” denotes only post-industrial waste as defined above. According to this embodiment, the composition of the invention is thus free of post-consumer waste as defined above.

In another particular embodiment of the invention, the expression “recycled aliphatic polyamide” denotes only post-consumer waste as defined above. According to this embodiment, the composition of the invention is thus free of post-industrial waste as defined above.

According to one embodiment, the recycled aliphatic polyamide used in the compositions of the invention does not come from a three-dimensional article manufactured from a composition in powder form, by layer-by-layer construction by sintering caused by electromagnetic radiation.

According to one embodiment, the composition of the invention is not intended to be used in the layer-by-layer construction of a three-dimensional article, by sintering of the composition caused by electromagnetic radiation

As mentioned below, the recycled aliphatic polyamide used according to the invention is modified relative to a virgin aliphatic polyamide. In particular, oxidative stresses during the manufacture of the original source material, its use and/or its subsequent recycling, or else during the manufacture of an object as defined above, its use and/or its subsequent recycling, affect some of its bonds, as for example its reactive functions and/or its hydrocarbon chain.

For example, in the case of post-consumer waste (such as spectacles or shoes), the articles have generally been exposed during their use, in whole or in part, to conditions that could affect some of their bonds, such conditions including, for example, air, in particular oxygen, light, in particular UV rays, or else temperature differences, in particular high temperatures. In the case of sports articles, the objects could also be exposed to the perspiration fluid of the persons who carried or wore them, to cosmetic products (for instance suncream), to cleaning products (for instance laundry-type detergents, notably at temperatures of greater than 30° C.), and also to products of degradation by microorganisms.

The bonds of the aliphatic polyamides can also be placed under oxidative stress by multiple processing, granulation and compounding operations (for example, recycling of post-industrial scrap, granulation, compounding and processing after the first life or lives of the material).

The aliphatic polyamides thus have specific features, and notably new species resulting from oxidation mechanisms, when they result from post-industrial waste and/or post-consumer waste as defined previously.

For the purposes of the invention, the term “new species resulting from oxidation mechanisms” is intended to denote primary amide functions, nitriles, chain-end methyl groups, alkenes, formamides, imides, carboxylic acids and alcohols which may be seen in the recycled aliphatic polyamide of the invention.

The recycled aliphatic polyamide of the invention has functions resulting from oxidation reactions chosen from primary amide functions, nitriles, chain-end methyl groups, alkenes, formamides, imides, carboxylic acids and alcohols.

According to a preferred embodiment of the invention, the recycled aliphatic polyamide of the invention has functions resulting from oxidation reactions chosen from nitriles and chain-end methyl groups.

According to a preferred embodiment of the invention, the recycled aliphatic polyamide of the invention has functions resulting from oxidation reactions chosen from nitriles and chain-end methyl groups in a mole ratio relative to the secondary amide functions higher than that of the same virgin aliphatic polyamide, and primary amine functions in a mole ratio relative to the secondary amide functions lower than that of the same virgin aliphatic polyamide.

These functions may be identified and quantified using infrared and/or proton or carbon NMR spectroscopy.

The NMR measurements may be performed in an HFIP/CD2Cl2 mixture. For example, 20 mg of polymer may be dissolved in 0.7 mL of solvent with an HFIP/CD2Cl2 ratio of 1/3. The dichloromethane (CD2Cl2)/trifluoroacetic anhydride (ATFA) mixture may also be used.

This method is described in the doctoral thesis by E. Goncalves in chapter II.2.3 published in 2011, incorporated by reference. Analyses in these two solvents allow the identification of a majority of functions formed during the life of the aliphatic polyamide.

Thus, by way of example, in infrared spectroscopy, the absorption band from 1700 to 1740 cm⁻¹ corresponds to an imide, that from 1680 to 1720 cm⁻¹ to the carbonyl of the carboxylic acid and that from 3580 to 3670 cm⁻¹ corresponds to the alcohol function of the carboxylic acid.

The absorption band from 3580 to 3670 cm⁻¹ corresponds to the free alcohol function.

The amide function is characterized firstly by a pair of absorption bands from 3100 to 3500 cm⁻¹ and from 1560 to 1640 cm⁻¹ which corresponds to the NH group of the amide, and secondly by the absorption band from 1650 to 1700 cm⁻¹ which corresponds to the carbonyl group of the amide.

The absorption bands at 1180 and 1723 cm⁻¹ correspond to the formates. The bands at 900 and 1660 cm⁻¹ correspond to the alkenes.

For example, the degradation of the polyethers included in the aliphatic polyamides, notably PEBAs, can be quantified by infrared spectroscopy by comparing the ratio between the intensities of the bands at 1111 cm⁻¹ (vibration of the C—O bond of the ether group) or at 2791 cm⁻¹ (CH2 α to the ether function) and the band at 1725 cm⁻¹ (carbonyl function).

Quantification by NMR is performed, for example, by comparing the intensity of the lines of the functions not present in the virgin polymer with the lines corresponding to the CH2 α to the amide, ether or other CH2 functions in the context of proton NMR. In carbon NMR, the intensity of the lines of the functions formed during the life of the polymer is compared to the intensity of the lines of the amide or CH2 carbons.

Some of the functions mentioned above may, for example, be observed in 13C NMR in HFIP/CD2Cl2 solvent. Thus, the line at 36 ppm corresponds to the CH2α to the primary amide, and that at 34 ppm corresponds to the CH2α to the carboxylic acid. These species may be quantified by integrating the area under the lines and comparing them with the area under the 37.1 ppm line corresponding to the secondary amide. Similarly, the lines corresponding to the carbonyl groups of the primary amide, carboxylic acid and secondary amide functions are observed at 181.2 ppm, 179.6 ppm and 177.4 ppm, respectively. The line at 16.7 ppm corresponds to the CH2α to the nitrile group. The formamide group gives chemical shifts at 163.0 ppm and 166.3 ppm.

Other functions mentioned above may be observed in proton NMR (1H NMR) in HFIP/CD2Cl2 solvent as described above. The line for the formamide CHO groups emerges at 7.92 and 8.01 ppm. The line corresponding to the CH2 groups a to the primary amides may be observed at 2.30 ppm. The 0.9 ppm line corresponds to the CH3 groups of the CH3-(CH2) n type. The line at 2.40 ppm corresponds to the CH2α to the nitrile function. The line corresponding to the proton of the formate function is observed at 8.1 ppm. The line corresponding to the proton of the aldehyde function is observed at 9.7 ppm. Similar to what is described for carbon NMR, the ratios of new functions relative to secondary amides may be determined by integrating the area under the lines and comparing them to the area under the line corresponding to the CH2α to the secondary amide (2.20 ppm) or to the area under the line corresponding to the CONH proton of the secondary amide (6.0-6.1 ppm).

According to any one of the embodiments of the invention, in a recycled aliphatic polyamide of the invention, the mole ratio of the functions resulting from oxidation reactions relative to the secondary amide functions is between 0.0005 and 0.3.

According to any one of the embodiments of the invention, in a recycled aliphatic polyamide of the invention, the mole ratio of imide functions to secondary amide functions is between 0.0005 and 0.1, notably between 0.001 and 0.08, in particular between 0.005 and 0.05.

According to any one of the embodiments of the invention, in a recycled aliphatic polyamide of the invention, the mole ratio of the carboxylic acid functions to the secondary amide functions is between 0.0005 and 0.1, notably between 0.001 and 0.08, in particular between 0.005 and 0.05.

According to any one of the embodiments of the invention, in a recycled aliphatic polyamide of the invention, the mole ratio of alcohol functions to secondary amide functions is between 0.0005 and 0.1, notably between 0.001 and 0.08, in particular between 0.005 and 0.05.

According to any one of the embodiments of the invention, in a recycled aliphatic polyamide of the invention, the mole ratio of the primary amide functions to the secondary amide functions is between 0.0005 and 0.1, notably between 0.001 and 0.08, in particular between 0.005 and 0.05.

According to any one of the embodiments of the invention, in a recycled aliphatic polyamide of the invention, the mole ratio of nitrile functions to secondary amide functions is between 0.0005 and 0.1, notably between 0.001 and 0.08, in particular between 0.005 and 0.05.

According to any one of the embodiments of the invention, in a recycled aliphatic polyamide of the invention, the mole ratio of alkene functions to secondary amide functions is between 0.0005 and 0.1, notably between 0.001 and 0.08, in particular between 0.005 and 0.05.

According to any one of the embodiments of the invention, in a recycled aliphatic polyamide of the invention, the mole ratio of formamide functions to secondary amide functions is between 0.0005 and 0.1, notably between 0.001 and 0.08, in particular between 0.005 and 0.05.

According to any one of the embodiments of the invention, in a recycled aliphatic polyamide of the invention, the mole ratio of the chain-end methyl functions to the secondary amide functions is between 0.0005 and 0.2, notably between 0.001 and 0.08, in particular between 0.005 and 0.05.

Needless to say, depending on the waste products and the exposure to which they have been subjected, one or more functions resulting from oxidizing reactions may be present.

The composition may also comprise residues of stabilizers chosen from phenols, quinones, stilbene quinones and phosphite.

The recycled aliphatic polyamide may also advantageously comprise alkyl chain ends with a carbon number (of between 2 and 20, in particular between 8 and 18, for example between 10 and 18) greater than that of a virgin polyamide. Advantageously, the content of alkyl chain ends as defined previously may be between 1 ppm and 0.5% by weight relative to the total weight of the aliphatic polyamide.

Also, the recycled aliphatic polyamides of the invention are generally more colored than the corresponding virgin aliphatic polyamides.

The optical properties of recycled thermoplastic aliphatic polyamides and virgin equivalents can be measured according to the standard ISO 53236:2018-02 in reflectance mode on a 2 mm thick plate with the following analysis parameters: D65 observer, light beam angle=10°, sensor aperture=25 mm and SCI analysis mode. The difference in hue between recycled and virgin product is expressed by a value ΔE. According to one embodiment, the recycled aliphatic polyamide of the invention has a ΔE value of greater than 5, advantageously greater than 10, more preferentially greater than 20, relative to the same virgin aliphatic polyamide.

The recycled aliphatic polyamides of the invention thus advantageously have greater laser absorption, and therefore better weldability and thermoformability, notably under infrared radiation. To carry out infrared thermoforming, the heating system generally has two infrared heating plates (upper and lower) to ensure uniform heating. The forming time is of the order of 1 s. A pressure of several bar is applied to obtain good thermoforming.

Compositions comprising recycled aliphatic polyamides according to the invention make it possible to perform thermoforming, notably under infrared radiation, more rapidly than compositions comprising virgin aliphatic polyamides. The use of recycled aliphatic polyamides of the invention thus advantageously increases productivity.

According to any one of the embodiments, the recycled aliphatic polyamide according to the invention may have a C/N ratio of greater than 6.5, advantageously greater than 7.5, preferably greater than 8.5.

The aliphatic polyamide of the invention may notably be a long-chain aliphatic polyamide having a number of carbon atoms per nitrogen atom greater than or equal to 6.5, advantageously greater than 7.5, preferably greater than 8.5, in particular greater than or equal to 10.

The nomenclature used to define polyamides is described in the standard ISO 1874-1:2011 “Plastics-Polyamide (PA) molding and extrusion materials-Part 1: Designation”, in particular on page 3 (Tables 1 and 2), and is well known to a person skilled in the art.

The polyamide can be a homopolyamide or a copolyamide or a blend of these.

Said polyamide is advantageously a semicrystalline polyamide or copolyamide.

For the purposes of the invention, the term “semicrystalline” denotes a (co) polyamide which has a melting temperature (Tm) in DSC according to the standard ISO 11357-3:2013, and an enthalpy of crystallization during the cooling step at a rate of 20 K/min in DSC measured in accordance with the standard ISO 11357-3 of 2013 which is greater than 20 J/g, preferably greater than 30 J/g.

According to one embodiment, the aliphatic polyamide of the invention is obtained by polycondensation:
of at least one C₉ to C₁₈, preferentially C₁₀ to C₁₈, notably C₁₀ to C₁₂, amino acid, or
of at least one C₉ to C₁₈, preferentially C₁₀ to C₁₈, notably C₁₀ to C₁₂, lactam, or of at least one aliphatic diamine Ca or of at least one C₄-C₃₆, preferentially C₆-C₁₈, preferentially C₆-C₁₂, more preferentially C₁₀-C₁₂, diamine Ca with at least one C₄-C₃₆, preferentially C₆-C₁₈, preferentially C₆-C₁₂, more preferentially C₁₀-C₁₂, dicarboxylic acid Cb, or a mixture thereof.

According to one embodiment, the aliphatic polyamide of the invention is obtained by polycondensation:
of at least one C₉ to C₁₈, preferentially C₁₀ to C₁₈, notably C₁₀ to C₁₂, amino acid, or
of at least one C₉ to C₁₈, preferentially C₁₀ to C₁₈, notably C₁₀ to C₁₂, lactam.

Said polyamide is derived from a repeating unit obtained by polycondensation:
of at least one C₆ to C₁₈, preferentially C₉ to C₁₈, more preferentially C₁₀ to C₁₂, amino acid, or
of at least one C₆ to C₁₈, preferentially C₉ to C₁₈, more preferentially C₁₀ to C₁₂, lactam, or
of at least one C₄-C₄₈, preferentially C₆-C₁₈, preferentially C₆-C₁₂, more preferentially C₁₀-C₁₂, diamine Ca with at least one C₄-C₄₈, preferentially C₆-C₁₈, preferentially C₆-C₁₂, more preferentially C₁₀-C₁₂, dicarboxylic acid Cb,
or a mixture thereof,
provided that the number of carbon atoms per nitrogen atom is greater than or equal to 6.5, advantageously greater than 7.5, preferably greater than 8.5, in particular greater than or equal to 10.

Advantageously, the long-chain aliphatic polyamide is obtained by polycondensation:
of at least one C₉ to C₁₈, preferentially C₁₀ to C₁₈, notably C₁₀ to C₁₂, amino acid, or
of at least one C₉ to C₁₈, preferentially C₁₀ to C₁₈, notably C₁₀ to C₁₂, lactam.

A C₉ to C₁₈ amino acid is in particular 9-aminononanoic acid, 10-aminodecanoic acid, 10-aminoundecanoic acid, 12-aminododecanoic acid and 11-aminoundecanoic acid and also derivatives thereof, in particular N-heptyl-11-aminoundecanoic acid.

A C₉ to C₁₈ lactam is in particular lauryllactam.

Said at least one C₄-C₄₈ diamine Ca may be chosen in particular from 1,4-butanediamine, 1,5-pentamethylenediamine, 1,6-hexamethylenediamine, 1,7-heptamethylenediamine, 1,8-octamethylenediamine, 1,9-nonamethylenediamine, 1,10-decamethylenediamine, 1,11-undecamethylenediamine, 1,12-dodecamethylenediamine, 1,13-tridecamethylenediamine, 1,14-tetradecamethylenediamine, 1,16-hexadecamethylenediamine and 1,18-octadecamethylenediamine, octadecenediamine, eicosanediamine, docosanediamine and diamines obtained from fatty acids.

Advantageously, said at least one diamine Ca is C₆-C₁₈ and is chosen from 1,6-hexamethylenediamine, 1,7-heptamethylenediamine, 1,8-octamethylenediamine, 1,9-nonamethylenediamine, 1,10-decamethylenediamine, 1,11-undecamethylenediamine, 1,12-dodecamethylenediamine, 1,13-tridecamethylenediamine, 1,14-tetradecamethylenediamine, 1,16-hexadecamethylenediamine and 1,18-octadecamethylenediamine.

Said at least one C₄-C₄₈ dicarboxylic acid Cb may be chosen from succinic acid, glutaric acid, adipic acid, suberic acid, azelaic acid, sebacic acid, undecanedioic acid, dodecanedioic acid, brassylic acid, tetradecanedioic acid, pentadecanedioic acid, hexadecanedioic acid, octadecanedioic acid, octadecenediamine, eicosanediamine, docosanediamine and diamines obtained from fatty acids.

Advantageously, said at least one dicarboxylic acid Cb is C₆-C₁₈ and is chosen from adipic acid, suberic acid, azelaic acid, sebacic acid, undecanedioic acid, dodecanedioic acid, brassylic acid, tetradecanedioic acid, pentadecanedioic acid, hexadecanedioic acid and octadecanedioic acid.

in particular, the long-chain aliphatic polyamide is chosen from: polyamide 410 (PA410), polyamide 510 (PA510), polyamide 610 (PA610), polyamide 612 (PA612), polyamide 1010 (PA1010), polyamide 1012 (PA1012), polyamide 1212 (PA1212), polyamide 11 (PA11), polyamide 12 (PA12), or a blend thereof or a copolyamide thereof.

Advantageously, the polyamide is in particular PA610, PA 612, PA11 and PA12.

In one embodiment, said long-chain aliphatic polyamide is a mixture of two polyamides in a weight ratio range from 5/95 to 95/5.

According to one embodiment of the invention, the recycled aliphatic polyamide of the invention preferably has an inherent viscosity of greater than or equal to 1.0 dL/g, notably greater than or equal to 1.15 dl/g.

For example, the recycled aliphatic polyamide of the invention may have an inherent viscosity of between 1.1 dL/g and 1.65 dL/g, for example between 1.2 dL/g and 1.55 dL/g.

The inherent viscosity is determined in m-cresol according to the standard ISO 307:2007 but with a change of solvent (using m-cresol instead of sulfuric acid and the temperature being 20° C.).

According to one embodiment, the recycled aliphatic polyamide of the invention is not in powder form.

In particular, according to one embodiment, the recycled aliphatic polyamide of the invention is not in the form of particles having a size Dv10 of greater than or equal to 30 μm and/or in the form of particles having a size Dv90 of less than or equal to 250 μm and/or in the form of particles having a size Dv50 of 80 to 150 μm.

In the context of the present patent application:
the Dv10 corresponds to the threshold of the particle size for which 10% of the particles (by volume) have a size less than the threshold, and 90% of the particles (by volume) have a size greater than the threshold;
the Dv50 corresponds to the threshold of the particle size for which 50% of the particles (by volume) have a size less than the threshold, and 50% of the particles (by volume) have a size greater than the threshold;
the Dv90 corresponds to the threshold of the particle size for which 90% of the particles (by volume) have a size less than the threshold, and 10% of the particles (by volume) have a size greater than the threshold.

The Dv10, the Dv50 and the Dv90 are measured according to the standard ISO 9276-Parts 1 to 6: “Representation of data obtained by particle size analysis”. It is possible to use, for example, a laser particle sizer (Sympatec Helos) and software (Fraunhofer) to obtain the volumetric distribution of a powder and to deduce the Dv10, the Dv50 and the Dv90 therefrom.

### Additives

Said recycled aliphatic polyamide, whether it comes from post-industrial waste or from post-consumer waste as defined previously, results from grades of aliphatic polyamides which may optionally comprise additives.

As indicated above, the compositions according to the invention comprise at least 0.1% by weight of at least one additive, relative to the total weight of said composition.

It is specified that the additive considered according to the invention is an additive which has been expressly added in a content of at least 0.1% by weight, relative to the total weight of the composition, to the recycled aliphatic polyamide in order to obtain a composition of the invention.

In other words, additives which may possibly already be present in the recycled aliphatic polyamide are not taken into account in the context of the present invention.

Used compositions having functions resulting from oxidation reactions as defined according to the invention are already partially degraded and cannot meet all the specifications unless they are reformulated.

It is notably important to add at least one additive, preferably a stabilizer, in particular a heat stabilizer, because all or part of the amount initially present of additive, notably of stabilizer, was consumed during the first life and/or the multiple processing steps that led to the formation of functions resulting from oxidation reactions as defined according to the invention.

In order to use these materials in high performance applications including criteria of durability over time, it is therefore essential according to the invention to add such an additive, preferably stabilizers, in particular heat stabilizers.

The compositions of the invention may notably comprise from 0.1% to 10% by weight of additives, relative to the total weight of said composition, notably from 0.3% to 6% by weight, for example from 0.5% to 2% by weight.

The additives present in the compositions of the invention are the conventional additives used and well known to those skilled in the art.

According to one embodiment, they may notably comprise at least one additive chosen from a catalyst, an antioxidant, a heat stabilizer, a UV absorber, a light stabilizer, a lubricant, a nucleating agent, a colorant, a wax and mixtures thereof.

The term “catalyst” denotes a polycondensation catalyst such as a mineral or organic acid.

Advantageously, the weight proportion of catalyst is from about 50 ppm to about 5000 ppm, in particular from about 100 to about 3000 ppm, relative to the total weight of the composition.

Advantageously, a derivative of a metal selected from the group formed of titanium, zirconium and hafnium, or a strong acid such as phosphoric acid, hypophosphorous acid or boric acid, is used as catalyst.

By way of example, the stabilizer may be a UV stabilizer, an organic stabilizer or more generally a combination of organic stabilizers, such as an antioxidant of phenol type (for example of the type such as Irganox® 245 or 1098 or 1010 from the company Ciba-BASF), an antioxidant of phosphite type (for example Irgafos® 126 and Irgafos® 168 from the company Ciba-BASF) and even optionally other stabilizers, such as a HALS, which means Hindered-Amine Light Stabilizer (for example Tinuvin® 770 from the company Ciba-BASF), a UV stabilizer (for example Tinuvin® 312 from the company Ciba), or a phosphorus-based stabilizer. Use may also be made of antioxidants of amine type, such as Naugard® 445 from the company Crompton or else polyfunctional stabilizers, such as Nylostab® S-EED from the company Clariant.

This stabilizer may also be a mineral stabilizer, such as a copper-based stabilizer. Examples of such mineral stabilizers that may be mentioned include copper acetates and halides. Incidentally, other metals, such as silver, may possibly be considered, but said metals are known to be less effective. These copper-based compounds are typically combined with halides of alkali metals, in particular of potassium.

According to one embodiment, the composition of the invention comprises less than 2% by mass, relative to its total weight, of flow agent, preferably less than 1% by mass, preferably less than 0.5% by mass, preferably less than 0.1% by mass; preferably, it does not comprise any flow agent.

The term “flow agent” is understood to mean an agent which makes it possible to improve the flowability and also the leveling of a copolymer powder during a sintering process.

According to one embodiment, the composition of the invention comprises less than 2% by mass, relative to its total weight, of flow agent in the form of particles having an average size (Dv50) of less than or equal to 20 μm, preferably less than or equal to 15 μm, preferably less than or equal to 10 μm, and more preferably less than or equal to 1 μm.

Preferably, the composition of the invention comprises less than 1% by mass, preferably less than 0.5% by mass, preferably less than 0.1% by mass, and preferably it does not comprise a flow agent in the form of particles having an average size (Dv50) of less than or equal to 20 μm, preferably less than or equal to 15 μm, preferably less than or equal to 10 μm, and more preferably less than or equal to 1 μm. For example, the composition of the invention does not comprise a flow agent in the form of particles with a size Dv50 ranging from 10 nm to 100 nm, from 100 nm to 1 μm, from 1 μm to 20 μm.

According to one embodiment, the composition of the invention comprises less than 2% by mass, relative to its total weight, of flow agent in the form of particles chosen from: silicas, precipitated silicas, hydrated silicas, vitreous silicas, fumed silicas, pyrogenic silicas, glassy phosphates, glassy borates, glassy oxides, amorphous alumina, titanium dioxide, talc, mica, kaolin, attapulgite, calcium silicates, alumina, magnesium silicates and mixtures thereof.

Preferably, the composition of the invention comprises less than 1% by mass, preferably less than 0.5% by mass, preferably less than 0.1% by mass, and preferably it does not comprise a flow agent in the form of particles chosen from: silicas, precipitated silicas, hydrated silicas, vitreous silicas, fumed silicas, pyrogenic silicas, glassy phosphates, glassy borates, glassy oxides, amorphous alumina, titanium dioxide, talc, mica, kaolin, attapulgite, calcium silicates, alumina, magnesium silicates and mixtures thereof.

### Virgin Polyamide

The compositions according to the invention may further comprise at least one virgin polyamide.

For the purposes of the invention, the term “virgin polyamide” is intended to denote a polyamide which is not recycled, that is to say a polyamide which does not result from post-industrial waste and/or post-consumer waste, as defined above.

In particular, the compositions of the invention may comprise from 0% to 70% by weight of at least one virgin polyamide, relative to the total weight of said composition.

According to one embodiment, the compositions of the invention may comprise from 0.1% to 50% by weight of at least one virgin polyamide, relative to the total weight of the composition, for example from 0.2% to 35% by weight, for example from 5% to 25% by weight.

According to any one of the embodiments of the invention, the virgin polyamide may be chosen from homopolyamides, copolyamides, and copolymers containing polyamide blocks and flexible blocks or mixtures thereof.

According to one embodiment, the virgin polyamide may also be a blend of polyamide and at least one other polymer, the polyamide forming the matrix and the other polymer or polymers forming the dispersed phase.

The virgin polyamide may preferably be a condensation product:
of one or more amino acids;
of one or more lactams; or
of one or more salts or mixtures of diamines with diacids.

As examples of an amino acid, mention may be made of α,ω-amino acids, such as aminocaproic, 7-aminoheptanoic, 11-aminoundecanoic, n-heptyl-11-aminoundecanoic and 12-aminododecanoic acids.

The lactam monomers comprise, preferably, between 3 and 12 carbon atoms on the main ring and may be substituted. As examples of a lactam, mention may be made of β,β-dimethylpropiolactam, α,α-dimethylpropiolactam, amylolactam, caprolactam, capryllactam, enantholactam, 2-pyrrolidone and lauryllactam.

Preferably, the diamine included in the composition of the virgin polyamide is an aliphatic diamine, an aryl diamine and/or a saturated cyclic diamine having from 6 to 12 carbon atoms. As examples of a diamine, mention may be made of hexamethylenediamine, decanediamine, piperazine, tetramethylenediamine, octamethylenediamine, decamethylenediamine, dodecamethylenediamine, 1,5-diaminohexane, 2,2,4-trimethyl-1,6-diaminohexane, polyol diamines, isophoronediamine (IPD), methylpentamethylenediamine (MPDM), bis(aminocyclohexyl) methane (BACM), bis(3-methyl-4-aminocyclohexyl) methane (BMACM), meta-xylylenediamine, bis(p-aminocyclohexyl) methane and trimethylhexamethylenediamine.

Preferably, the dicarboxylic acid included in the composition of the virgin polyamide contains between 4 and 18 carbon atoms. As examples of a dicarboxylic acid, mention may be made of adipic acid, sebacic acid, azelaic acid, suberic acid, isophthalic acid, butanedioic acid, 1,4-cyclohexanedicarboxylic acid, terephthalic acid, the sodium or lithium salt of sulfoisophthalic acid, dimerized fatty acids (these dimerized fatty acids have a dimer content of at least 98% and are preferably hydrogenated) and dodecanedioic acid HOOC—(CH₂)₁₀—COOH).

Preferably, the virgin copolyamide results from the condensation of at least two different monomers, for example of at least two different alpha, omega-aminocarboxylic acids or of two different lactams or of a lactam and of an alpha, omega-aminocarboxylic acid with different carbon numbers. Mention may also be made of copolyamides resulting from the condensation of at least one α,ω-aminocarboxylic acid (or one lactam), at least one diamine and at least one dicarboxylic acid. Mention may also be made of copolyamides resulting from the condensation of an aliphatic diamine with an aliphatic dicarboxylic acid and at least one other monomer chosen from aliphatic diamines other than the preceding one and aliphatic diacids other than the preceding one.

Preferably, the virgin polyamide may comprise at least one polyamide or copolyamide comprising at least one monomer selected from the group consisting of 46, 4T, 54, 59, 510, 512, 513, 514, 516, 518, 536, 6, 64, 66, 69, 610, 612, 613, 614, 616, 618, 636, 6T, 9, 913, 104, 109, 1010, 1011, 1012, 1013, 1014, 1016, 1018, 1036, 10T, 11, 12, 124, 129, 1210, 1212, 1213, 1214, 1216, 1218, 1236, 12T, MXD6, MXD10, MXD12, MXD14, and mixtures thereof.

Preferably, the virgin polyamide is selected from the group consisting of PA 6, PA 66, PA 1010, PA 11, PA 12, PA 1011, PA 610, PA 612, PA 613 and mixtures thereof.

As examples of copolyamides, mention may be made of copolymers of caprolactam and of lauryllactam (PA 6/12), copolymers of caprolactam, of adipic acid and of hexamethylenediamine (PA 6/66), copolymers of caprolactam, of lauryllactam, of adipic acid and of hexamethylenediamine (PA Jun. 12, 1966), copolymers of caprolactam, of lauryllactam, of 11-aminoundecanoic acid, of azelaic acid and of hexamethylenediamine (PA 6/69/11/12), copolymers of caprolactam, of lauryllactam, of 11-aminoundecanoic acid, of adipic acid and of hexamethylenediamine (PA 6/66/11/12), copolymers of lauryllactam, of azelaic acid and of hexamethylenediamine (PA 69/12), copolymers of 11-aminoundecanoic acid, of terephthalic acid and of decamethylenediamine (PA 11/10T).

Preferably, the average number of carbon atoms (C) relative to the nitrogen atom (N) (that is to say the C/N ratio) of the virgin polyamide is greater than 6.5, advantageously greater than 7.5, preferably greater than 8.5, notably greater than or equal to 10, preferably greater than or equal to 11. With particular preference, the average number of carbon atoms (C) relative to the nitrogen atom (N) of the virgin polyamide is 11 or 12.

Preferably, the virgin polyamide is chosen from PA 11, PA 1010, PA 1012, PA 12, PA 1212, PA 1014 or PA 1214 and mixtures thereof, preferably from PA11 or PA12 or a mixture thereof.

It may also be a copolymer comprising polyamide blocks and flexible blocks as defined, for example, in patent application WO 2019/097 184 in the name of Arkema France, and notably a copolymer comprising polyamide blocks and polyether blocks (PEBA).

Preferably, the polyamide of the rigid block of said PEBA may have a C/N ratio of greater than 6.5, advantageously greater than 7.5, preferably greater than 8.5.

The nomenclature used to define polyamides is described in the standard ISO 1874-1:2010 “Plastics-Polyamide (PA) molding and extrusion materials-Part 1: Designation”, in particular on page 3 (Tables 1 and 2), and is well known to a person skilled in the art.

According to a preferred embodiment of the invention, the aliphatic polyamide of the invention and the virgin polyamide (or the polyamide block of the virgin PEBA) have the same C/N ratio. For example, the aliphatic polyamide of the invention may be PA11 and the virgin polyamide (or the polyamide block of the virgin PEBA) may be PA1012.

According to another preferred embodiment of the invention, the aliphatic polyamide of the invention and the virgin polyamide (or the polyamide block of the virgin PEBA) are identical in nature. For example, the aliphatic polyamide of the invention may be PA12 and the virgin polyamide (or the polyamide block of the virgin PEBA) may be PA12. According to another example, the aliphatic polyamide of the invention may be PA11 and the virgin polyamide (or the polyamide block of the virgin PEBA) may be PA11.

According to yet another embodiment of the invention, the difference between, on the one hand, the C/N ratio of the aliphatic polyamide of the invention and, on the other hand, the C/N ratio of the virgin polyamide (or of the polyamide block of the virgin PEBA) may be less than or equal to 3, notably less than or equal to 2, notably less than or equal to 1. For example, the aliphatic polyamide of the invention may be PA12 and the virgin polyamide (or the polyamide block of the virgin PEBA) may be PA11. According to another example, the aliphatic polyamide of the invention may be PA12 and the virgin polyamide (or the polyamide block of the virgin PEBA) may be PA11.

According to one embodiment of the invention, the virgin polyamide preferably has an inherent viscosity of greater than or equal to 1.0 dL/g, notably greater than or equal to 1.15 dL/g.

For example, the virgin polyamide may have an inherent viscosity of between 1.1 dl/g and 1.65 dL/g, for example between 1.2 dL/g and 1.55 dL/g.

The inherent viscosity is determined in m-cresol according to the standard ISO 307:2007 but with a change of solvent (using m-cresol instead of sulfuric acid and the temperature being 20° C.).

### Impact Modifier

The compositions according to the invention may further comprise at least one impact modifier.

In particular, the compositions of the invention may comprise from 0% to 30% by weight of at least one impact modifier, relative to the total weight of said composition.

According to one embodiment, the compositions of the invention may comprise from 1% to 25% by weight of at least one impact modifier, relative to the total weight of the composition, for example from 3% to 20% by weight, for example from 6% to 15% by weight.

The impact modifier advantageously consists of a polymer with a flexural modulus of less than 100 MPa measured according to the standard ISO 178:2010, determined at 23° C. with a relative humidity: RH of 50%, and a Tg of less than 0° C. (measured according to the standard 11357-2:2013 at the inflection point of the DSC thermogram, at a heating rate of 20 K/min), in particular a polyolefin.

The polyolefin of the impact modifier may be functionalized or non-functionalized or be a mixture of at least one which is functionalized and/or of at least one which is non-functionalized. For simplification, the polyolefin has been denoted (B) and functionalized polyolefins (B1) and nonfunctionalized polyolefins (B2) have been described below.

A nonfunctionalized polyolefin (B2) is conventionally a homopolymer or copolymer of alpha-olefins or of diolefins, for instance ethylene, propylene, 1-butene, 1-octene or butadiene. Examples that may be mentioned include:
polyethylene homopolymers and copolymers, in particular LDPE, HDPE, LLDPE (linear low density polyethylene), VLDPE (very low density polyethylene) and metallocene polyethylene,
propylene homopolymers or copolymers,
ethylene/alpha-olefin, such as ethylene/propylene, copolymers, EPRs (abbreviation for ethylene propylene rubber) and ethylene/propylene/diene (EPDM) copolymers,
styrene/ethylene-butene/styrene (SEBS), styrene/butadiene/styrene (SBS), styrene/isoprene/styrene (SIS) and styrene/ethylene-propylene/styrene (SEPS) block copolymers,
copolymers of ethylene with at least one product chosen from salts or esters of unsaturated carboxylic acids, such as alkyl (meth)acrylate (for example methyl acrylate), or vinyl esters of saturated carboxylic acids, such as vinyl acetate (EVA), it being possible for the proportion of comonomer to be up to 40% by weight.

The functionalized polyolefin (B1) may be a polymer of alpha-olefins having reactive units (the functionalities); such reactive units are acid, anhydride or epoxy functions. By way of example, mention may be made of the preceding polyolefins (B2) grafted or copolymerized or terpolymerized with unsaturated epoxides, such as glycidyl (meth)acrylate, or with carboxylic acids or the corresponding salts or esters, such as (meth)acrylic acid (it being possible for the latter to be completely or partially neutralized with metals such as Zn, etc.), or else with carboxylic acid anhydrides, such as maleic anhydride. A functionalized polyolefin is, for example, a PE/EPR mixture, the weight ratio of which can vary within broad limits, for example between 40/60 and 90/10, said mixture being cografted with an anhydride, notably maleic anhydride, in a degree of grafting of, for example, from 0.01% to 5% by weight.

The functionalized polyolefin (B1) may be chosen from the following (co) polymers, grafted with maleic anhydride or glycidyl methacrylate, in which the degree of grafting is, for example, from 0.01% to 5% by weight:
PE, PP, copolymers of ethylene with propylene, butene, hexene or octene containing, for example, from 35% to 80% by weight of ethylene;
ethylene/alpha-olefin, such as ethylene/propylene, copolymers, EPRs (abbreviation for ethylene propylene rubber) and ethylene/propylene/diene (EPDM) copolymers,
styrene/ethylene-butene/styrene (SEBS), styrene/butadiene/styrene (SBS), styrene/isoprene/styrene (SIS) and styrene/ethylene-propylene/styrene (SEPS) block copolymers,
copolymers of ethylene and vinyl acetate (EVA), containing up to 40% by weight of vinyl acetate;
copolymers of ethylene and alkyl (meth)acrylate, containing up to 40% by weight of alkyl (meth)acrylate;
copolymers of ethylene and vinyl acetate (EVA) and alkyl (meth)acrylate, containing up to 40% by weight of comonomers.

The functionalized polyolefin (B1) may also be chosen from ethylene/propylene copolymers, predominant in propylene, grafted with maleic anhydride and then condensed with monoamino polyamide (or polyamide oligomer) (products described in EP-A-0342066).

The functionalized polyolefin (B1) may also be a copolymer or terpolymer of at least the following units: (1) ethylene, (2)alkyl (meth)acrylate or saturated carboxylic acid vinyl ester and (3) anhydride such as maleic anhydride, or (meth)acrylic acid, or epoxy, such as glycidyl (meth)acrylate.

As examples of functionalized polyolefins of the latter type, mention may be made of the following copolymers, where ethylene preferably represents at least 60% by weight and where the termonomer (the function) represents, for example, from 0.1% to 10% by weight of the copolymer:
ethylene/alkyl (meth)acrylate/(meth)acrylic acid or maleic anhydride or glycidyl methacrylate copolymers;
ethylene/vinyl acetate/maleic anhydride or glycidyl methacrylate copolymers;
ethylene/vinyl acetate or alkyl (meth)acrylate/(meth)acrylic acid or maleic anhydride or glycidyl methacrylate copolymers.

In the preceding copolymers, the (meth)acrylic acid can be salified with Zn or Li.

The term “alkyl (meth)acrylate” in (B1) or (B2) denotes C1-C8 alkyl methacrylates and acrylates and may be chosen from methyl acrylate, ethyl acrylate, n-butyl acrylate, isobutyl acrylate, 2-ethylhexyl acrylate, cyclohexyl acrylate, methyl methacrylate and ethyl methacrylate.

Moreover, the abovementioned polyolefins (B1) may also be crosslinked via any suitable process or agent (diepoxy, diacid, peroxide, etc.); the term “functionalized polyolefin” also includes mixtures of the abovementioned polyolefins with a difunctional reagent such as diacid, dianhydride, diepoxy, etc. that is capable of reacting with these polyolefins, or mixtures of at least two functionalized polyolefins that can react with each other.

The abovementioned copolymers, (B1) and (B2), may be copolymerized in random or block fashion and may have a linear or branched structure.

The molecular weight, the MFI index and the density of these polyolefins may also vary within a broad range, as those skilled in the art will appreciate. MFI is the abbreviation for the Melt Flow Index. It is measured according to the standard ASTM 1238.

Advantageously, the nonfunctionalized polyolefins (B2) are chosen from polypropylene homopolymers or copolymers and any ethylene homopolymer or copolymer of ethylene and of a comonomer of higher alpha-olefin type, such as butene, hexene, octene, or 4-methyl-1-pentene. Mention may be made, for example, of PPs, high density PEs, medium density PEs, linear low density PEs, low density PEs or very low density PEs. These polyethylenes are known to those skilled in the art as being produced according to a “radical” process, according to a “Ziegler” type catalysis or, more recently, according to a “metallocene” catalysis.

Advantageously, the functionalized polyolefins (B1) are chosen from any polymer comprising alpha-olefin units and units bearing polar reactive functions, such as epoxy, carboxylic acid or carboxylic acid anhydride functions. By way of example of such polymers, mention may be made of terpolymers of ethylene, alkyl acrylate and maleic anhydride or glycidyl methacrylate, such as the Lotader® products from SK Functional Polymer, or polyolefins grafted with maleic anhydride, such as the Orevac® products from SK Functional Polymer, and also terpolymers of ethylene, alkyl acrylate and (meth)acrylic acid. Mention may also be made of polypropylene homopolymers or copolymers grafted with a carboxylic acid anhydride and then condensed with polyamides or monoamino polyamide oligomers.

### Filler

The compositions according to the invention may further comprise at least one filler.

In particular, the compositions of the invention may comprise from 0% to 65% by weight of at least one filler, relative to the total weight of said composition.

According to one embodiment, the compositions of the invention may comprise from 2% to 30% by weight of at least one filler, relative to the total weight of the composition, for example from 5% to 25% by weight, for example from 6% to 20% by weight.

The fillers may be chosen from:
the reinforcing fibers may be chosen from glass fibers, carbon fibers, natural fibers (wood, linen, cellulose, hemp, etc.)
current-conducting fillers such as carbon black and carbon nanotubes
flame retardants (HFFR)
fillers which reduce the density of the composition such as glass beads, notably hollow beads
heat-conducting fillers chosen from metal oxides (Al₂O₃, Al₂SiO₅, etc.), ceramics (BN, AlN, etc.)

According to one embodiment, a composition of the invention may notably comprise reinforcing fibers, which are notably fibers of mineral, organic or plant origin.

Said reinforcing fiber may or may not be sized.

Said reinforcing fibre may thus comprise up to 0.1% by weight of a material of organic nature (thermosetting or thermoplastic resin type) known as sizing.

Mention may be made, among the fibers of mineral origin, of carbon fibers, glass fibers, basalt fibers or basalt-based fibers, silica fibers or silicon carbide fibers, for example. Mention may be made, among the fibers of organic origin, of fibers based on thermoplastic or thermosetting polymer, such as semiaromatic polyamide fibers, aramid fibers or polyolefin fibers, for example. Mention may be made, among the fibers of plant origin, of natural fibers based on flax, hemp, lignin, bamboo, silk, in particular spider silk, sisal, and other cellulose fibers, in particular viscose fibers. These fibers of plant origin can be used pure, treated or else coated with a coating layer, for the purpose of facilitating the adhesion and the impregnation of the thermoplastic polymer matrix.

Preferably, said reinforcing fiber is chosen from glass fibers, carbon fibers, basalt fibers and basalt-based fibers.

More advantageously, said reinforcing fiber is chosen from carbon fibers and glass fibers.

In one embodiment, the reinforcing fibers present in a) are glass fibers.

The glass fibers may be of circular or non-circular cross section. Advantageously, the glass fibers are circular. The glass fibers are notably of type E, R, S2 or T. Advantageously, the glass fibers are of type E.

In one embodiment, the fillers are recycled. In the case of fillers comprising glass, they may notably be manufactured from industrial production waste or post-consumer glass. The carbon fibers may, for example, come from the cutting of reels of expired long fibers, in particular carbon fibers for aeronautics.

### Plasticizers

The compositions according to the invention may further comprise at least one plasticizer.

In particular, the compositions of the invention may comprise from 0% to 15% by weight of at least one plasticizer, relative to the total weight of said composition.

According to one embodiment, the compositions of the invention may comprise from 4% to 13% by weight of at least one plasticizer, relative to the total weight of the composition, for example from 6% to 12% by weight.

By way of example, the plasticizers are chosen from benzenesulfonamide derivatives, such as n-butylbenzenesulfonamide (BBSA); ethyltoluenesulfonamide or N-cyclohexyltoluenesulfonamide; hydroxybenzoic acid esters such as 2-ethylhexyl para-hydroxybenzoate and 2-hexyldecyl para-hydroxybenzoate; tetrahydrofurfuryl alcohol esters or ethers such as oligoethyleneoxytetrahydrofurfuryl alcohol; and esters of citric acid or of hydroxymalonic acid, such as oligoethyleneoxy malonate.

It would not constitute a departure from the scope of the invention to use a mixture of plasticizers.

### Composition, Use and Process

As indicated above, the compositions of the invention comprise at least:
(a) from 30% to 99.9% by weight of at least one recycled aliphatic polyamide having functions resulting from oxidation reactions chosen from primary amide functions, nitriles, chain-end methyl groups, alkenes, formamides, imides, carboxylic acids, alcohols and mixtures thereof in a mole ratio, relative to the secondary amide functions, which is greater than that of the same virgin aliphatic polyamide and/or of at least one recycled aliphatic polyamide having primary amine functions in a mole ratio, relative to the secondary amide functions, which is lower than that of the same virgin aliphatic polyamide,
(b) from 0.1% to 10% by weight of at least one additive,
(c) from 0% to 70% by weight of at least one virgin polyamide,
(d) from 0% to 65% by weight of at least one filler,
(e) from 0% to 15% by weight of at least one plasticizer,
(f) from 0% to 30% by weight of at least one impact modifier.

In particular, according to one embodiment, the compositions of the invention comprise:
(a) from 30% to 99.9% by weight of at least one recycled aliphatic polyamide having functions resulting from oxidation reactions chosen from primary amide functions, nitriles, chain-end methyl groups, alkenes, formamides, imides, carboxylic acids, alcohols and mixtures thereof in a mole ratio, relative to the secondary amide functions, which is greater than that of the same virgin aliphatic polyamide and/or of at least one recycled aliphatic polyamide having primary amine functions in a mole ratio, relative to the secondary amide functions, which is lower than that of the same virgin aliphatic polyamide,
(b) from 0.1% to 10% by weight of at least one additive,
(c) from 0% to 70% by weight of at least one virgin polyamide,
(d) from 0% to 65% by weight of at least one filler,
(e) from 0% to 15% by weight of at least one plasticizer, and
(f) from 0% to 30% by weight of at least one impact modifier.
the sum of the constituents (a)-(f) being equal to 100%.

According to one embodiment, the compositions of the invention comprise:
(a) from 30% to 99.9% by weight of at least one recycled aliphatic polyamide having functions resulting from oxidation reactions chosen from primary amide functions, nitriles, chain-end methyl groups, alkenes, formamides, imides, carboxylic acids, alcohols and mixtures thereof in a mole ratio, relative to the secondary amide functions, which is greater than that of the same virgin aliphatic polyamide and/or of at least one recycled aliphatic polyamide having primary amine functions in a mole ratio, relative to the secondary amide functions, which is lower than that of the same virgin aliphatic polyamide,
(b) from 0.1% to 10% by weight of at least one additive,
(c) from 0% to 70% by weight of at least one virgin polyamide,
(d) from 0% to 65% by weight of at least one filler, and
(e) from 0% to 15% by weight of at least one plasticizer,
the sum of the constituents (a)-(e) being equal to 100%.

In particular, according to this embodiment, the compositions of the invention consist of:
(a) from 30% to 99.9% by weight of at least one recycled aliphatic polyamide having functions resulting from oxidation reactions chosen from primary amide functions, nitriles, chain-end methyl groups, alkenes, formamides, imides, carboxylic acids, alcohols and mixtures thereof in a mole ratio, relative to the secondary amide functions, which is greater than that of the same virgin aliphatic polyamide and/or of at least one recycled aliphatic polyamide having primary amine functions in a mole ratio, relative to the secondary amide functions, which is lower than that of the same virgin aliphatic polyamide,
(b) from 0.1% to 10% by weight of at least one additive,
(c) from 0% to 70% by weight of at least one virgin polyamide,
(d) from 0% to 65% by weight of at least one filler, and
(e) from 0% to 15% by weight of at least one plasticizer,
the sum of the constituents (a)-(e) being equal to 100%.

According to another embodiment, the compositions of the invention comprise:
(a) from 30% to 99.9% by weight of at least one recycled aliphatic polyamide having functions resulting from oxidation reactions chosen from primary amide functions, nitriles, chain-end methyl groups, alkenes, formamides, imides, carboxylic acids, alcohols and mixtures thereof in a mole ratio, relative to the secondary amide functions, which is greater than that of the same virgin aliphatic polyamide and/or of at least one recycled aliphatic polyamide having primary amine functions in a mole ratio, relative to the secondary amide functions, which is lower than that of the same virgin aliphatic polyamide,
(b) from 0.1% to 10% by weight of at least one additive,
(c) from 0% to 70% by weight of at least one virgin polyamide,
(d) from 0% to 65% by weight of at least one filler, and
(e) from 0% to 30% by weight of at least one impact modifier,
the sum of the constituents (a)-(e) being equal to 100%.

In particular, according to this embodiment, the compositions of the invention consist of:
(a) from 30% to 99.9% by weight of at least one recycled aliphatic polyamide having functions resulting from oxidation reactions chosen from primary amide functions, nitriles, chain-end methyl groups, alkenes, formamides, imides, carboxylic acids, alcohols and mixtures thereof in a mole ratio, relative to the secondary amide functions, which is greater than that of the same virgin aliphatic polyamide and/or of at least one recycled aliphatic polyamide having primary amine functions in a mole ratio, relative to the secondary amide functions, which is lower than that of the same virgin aliphatic polyamide,
(b) from 0.1% to 10% by weight of at least one additive,
(c) from 0% to 70% by weight of at least one virgin polyamide,
(d) from 0% to 65% by weight of at least one filler, and
(e) from 0% to 30% by weight of at least one impact modifier,
the sum of the constituents (a)-(e) being equal to 100%.

According to one embodiment, the compositions of the invention comprise:
(a) from 30% to 99.9% by weight of at least one recycled aliphatic polyamide having functions resulting from oxidation reactions chosen from primary amide functions, nitriles, chain-end methyl groups, alkenes, formamides, imides, carboxylic acids, alcohols and mixtures thereof in a mole ratio, relative to the secondary amide functions, which is greater than that of the same virgin aliphatic polyamide and/or of at least one recycled aliphatic polyamide having primary amine functions in a mole ratio, relative to the secondary amide functions, which is lower than that of the same virgin aliphatic polyamide,
(b) from 0.1% to 10% by weight of at least one additive,
(c) from 0% to 70% by weight of at least one virgin polyamide,
(d) from 0% to 15% by weight of at least one plasticizer, and
(e) from 0% to 30% by weight of at least one impact modifier,
the sum of the constituents (a)-(e) being equal to 100%.

In particular, according to this embodiment, the compositions of the invention consist of:
(a) from 30% to 99.9% by weight of at least one recycled aliphatic polyamide having functions resulting from oxidation reactions chosen from primary amide functions, nitriles, chain-end methyl groups, alkenes, formamides, imides, carboxylic acids, alcohols and mixtures thereof in a mole ratio, relative to the secondary amide functions, which is greater than that of the same virgin aliphatic polyamide and/or of at least one recycled aliphatic polyamide having primary amine functions in a mole ratio, relative to the secondary amide functions, which is lower than that of the same virgin aliphatic polyamide,
(b) from 0.1% to 10% by weight of at least one additive,
(c) from 0% to 70% by weight of at least one virgin polyamide,
(d) from 0% to 15% by weight of at least one plasticizer, and
(e) from 0% to 30% by weight of at least one impact modifier,
the sum of the constituents (a)-(e) being equal to 100%.

According to yet another embodiment, the compositions of the invention comprise:
(a) from 30% to 99.9% by weight of at least one recycled aliphatic polyamide having functions resulting from oxidation reactions chosen from primary amide functions, nitriles, chain-end methyl groups, alkenes, formamides, imides, carboxylic acids, alcohols and mixtures thereof in a mole ratio, relative to the secondary amide functions, which is greater than that of the same virgin aliphatic polyamide and/or of at least one recycled aliphatic polyamide having primary amine functions in a mole ratio, relative to the secondary amide functions, which is lower than that of the same virgin aliphatic polyamide,
(b) from 0.1% to 10% by weight of at least one additive,
(c) from 0% to 70% by weight of at least one virgin polyamide,
(d) from 0% to 65% by weight of at least one filler,
(e) from 0% to 15% by weight of at least one plasticizer, and
(f) from 0% to 30% by weight of at least one impact modifier,
the sum of the constituents (a)-(f) being equal to 100%.

In particular, according to this embodiment, the compositions of the invention consist of:
(a) from 30% to 99.9% by weight of at least one recycled aliphatic polyamide having functions resulting from oxidation reactions chosen from primary amide functions, nitriles, chain-end methyl groups, alkenes, formamides, imides, carboxylic acids, alcohols and mixtures thereof in a mole ratio, relative to the secondary amide functions, which is greater than that of the same virgin aliphatic polyamide and/or of at least one recycled aliphatic polyamide having primary amine functions in a mole ratio, relative to the secondary amide functions, which is lower than that of the same virgin aliphatic polyamide,
(b) from 0.1% to 10% by weight of at least one additive,
(c) from 0% to 70% by weight of at least one virgin polyamide,
(d) from 0% to 65% by weight of at least one filler,
(e) from 0% to 15% by weight of at least one plasticizer, and
(f) from 0% to 30% by weight of at least one impact modifier,
the sum of the constituents (a)-(f) being equal to 100%.

According to yet another embodiment, the compositions of the invention comprise:
(a) from 30% to 99.9% by weight of at least one recycled aliphatic polyamide having functions resulting from oxidation reactions chosen from primary amide functions, nitriles, chain-end methyl groups, alkenes, formamides, imides, carboxylic acids, alcohols and mixtures thereof in a mole ratio, relative to the secondary amide functions, which is greater than that of the same virgin aliphatic polyamide and/or of at least one recycled aliphatic polyamide having primary amine functions in a mole ratio, relative to the secondary amide functions, which is lower than that of the same virgin aliphatic polyamide,
(b) from 0.1% to 10% by weight of at least one additive,
(c) from 0% to 70% by weight of at least one virgin polyamide, and
(d) from 0% to 65% by weight of at least one filler,
the sum of the constituents (a)-(d) being equal to 100%.

In particular, according to this embodiment, the compositions of the invention consist of:
(a) from 30% to 99.9% by weight of at least one recycled aliphatic polyamide having functions resulting from oxidation reactions chosen from primary amide functions, nitriles, chain-end methyl groups, alkenes, formamides, imides, carboxylic acids, alcohols and mixtures thereof in a mole ratio, relative to the secondary amide functions, which is greater than that of the same virgin aliphatic polyamide and/or of at least one recycled aliphatic polyamide having primary amine functions in a mole ratio, relative to the secondary amide functions, which is lower than that of the same virgin aliphatic polyamide,
(b) from 0.1% to 10% by weight of at least one additive,
(c) from 0% to 70% by weight of at least one virgin polyamide,
(d) from 0% to 65% by weight of at least one filler, and the sum of the constituents (a)-(d) being equal to 100%.

According to one embodiment, the composition of the invention is different from a composition comprising 55% by weight of a recycled copolymer comprising rigid polyamide blocks and flexible polyether blocks (PEBA), 44.5% by weight of a polyamide 11 and 0.5% by weight of an antioxidant.

According to one embodiment, the composition of the invention is different from a composition comprising 90% by weight of a recycled copolymer comprising rigid polyamide blocks and flexible polyether blocks (PEBA), 9.5% by weight of a polyamide 11 and 0.5% by weight of an antioxidant.

According to one embodiment, the composition of the invention is different from a composition comprising 20% by weight of a recycled copolymer comprising rigid polyamide blocks and flexible polyether blocks (PEBA), 79.5% by weight of a polyamide 11 and 0.5% by weight of an antioxidant.

According to one embodiment, the composition of the invention is different from a composition comprising 99.5% by weight of a recycled copolymer comprising rigid polyamide blocks and flexible polyether blocks (PEBA) and 0.5% by weight of an antioxidant.

According to one embodiment, the recycled aliphatic polyamide of the invention does not originate from a used monolayer and/or multilayer tube and/or tank that initially conveyed or contained fluids for motor vehicles, notably for automobiles.

According to one embodiment, the composition of the invention is not intended for manufacturing tubes for transporting fluids for motor vehicles, notably for automobiles.

According to one embodiment, the recycled aliphatic polyamide according to the invention does not come from a tube.

According to one embodiment, the composition of the invention comprises less than 5% by weight of plasticizer, for example less than 3% by weight of plasticizer, for example less than 1% by weight of plasticizer, for example less than 0.5% by weight of plasticizer, relative to the total weight of the composition. In particular, the composition of the invention may be free of plasticizer, that is to say contain 0% by weight of plasticizer, relative to the total weight of the composition.

According to one embodiment, the composition of the invention comprises less than 5% by weight of impact modifier, for example less than 3% by weight of impact modifier, for example less than 1% by weight of impact modifier, for example less than 0.5% by weight of impact modifier, relative to the total weight of the composition. In particular, the composition of the invention may be free of impact modifier, that is to say contain 0% by weight of impact modifier, relative to the total weight of the composition.

According to one embodiment, the composition of the invention comprises less than 5% by weight of plasticizer and impact modifier, for example less than 3% by weight of plasticizer and impact modifier, for example less than 1% by weight of plasticizer and impact modifier, for example, less than 0.5% by weight of plasticizer and impact modifier, relative to the total weight of the composition. In particular, the composition of the invention may be free of plasticizer and impact modifier, that is to say contain 0% by weight of plasticizer and impact modifier, relative to the total weight of the composition.

According to one embodiment, the composition of the invention comprises only one or more recycled polyamides of the same nature.

According to any one of the embodiments of the invention, the composition of the invention may be in the form of solid particles with a median diameter D50 of less than 20 mm, preferably of between 0.1 and 10 mm.

The inventors have discovered, surprisingly, that the compositions of the invention have better processability, compared in particular with compositions free of recycled aliphatic polyamide. In particular, the compositions of the invention advantageously have a longer injection flow length than the same composition in which the aliphatic polyamide is not recycled.

According to another of its aspects, the invention thus relates to the use of a composition as defined previously, for giving said composition a longer injection flow length relative to the same composition in which the aliphatic polyamide is not recycled.

As indicated previously, the compositions of the invention advantageously have properties sufficient to enable their use for high performance applications, and not only in lower performance applications such as in street furniture or roads.

In particular, it has been demonstrated that the compositions of the invention enable the manufacture of objects, in particular mono-material objects, which have good mechanical properties.

Advantageously, the compositions of the invention can also enable the maintenance of good mechanical properties (for example in terms of impact strength, low density, modulus, stress and elongation at threshold, breaking stress and elongation at break) and the ability to adhere to different substrates similar to those of virgin polymers.

Advantageously, the compositions of the invention can also enable the maintenance of a chemical resistance that is similar to that of virgin polymers.

Accordingly, according to another of its aspects, the present invention relates to the use of a composition as defined previously for manufacturing objects, in particular mono-material objects.

According to another of its aspects, the present invention also relates to an object, in particular a mono-material object, consisting of at least 30% by weight, preferably of at least 50% by weight of a composition according to the invention.

It may notably be a mono-material object comprising at least two elements:
at least one first element consisting of a first composition comprising by weight at least 30% of at least one recycled aliphatic polyamide as defined previously,
at least one second element consisting of a second composition comprising by weight at least 30% of at least one recycled aliphatic polyamide as defined previously,
   said first and second elements being able to adhere at least partially to each other.

The term “mono-material object” should be understood to mean an object predominantly consisting of the same material, in this case a recycled aliphatic polyamide, in both compositions.

In a first variant, the mono-material objects may be, but are not limited to, the following:
an electronic article, in particular a watch, a telephone case, headphones, earphones, a loudspeaker, a keyboard, a mouse, a telephone charger,
an article of clothing, in particular a jacket, trousers, a T-shirt or socks,
an optical article, in particular prescription glasses, sunglasses, children's glasses, sports glasses and a ski mask, augmented reality/virtual reality goggles,
a household electrical article, in particular a small household electrical appliance, a household electrical article accessory (bowl, mixing paddle, food container), a flask, a food container,
a cosmetic article, in particular cosmetic packaging such as a bottle, a fragrance, makeup packaging, skincare packaging, a display article, a hairbrush,
a sports article, in particular a surfboard (and its accessories such as a leash or daggerboards), a bicycle, a bicycle article such as a saddle or pedal, a helmet, a ski boot, skis, ski poles, a ski binding and a snowboard (excluding metal), a golf club, any type of racket, in particular a tennis racket, protective equipment such as a shin guard, elbow pad, etc., a hockey cross (on grass or ice), a roller skate, diving flippers,
a luggage article, in particular a suitcase, a rucksack and a handbag,
a stationery article, in particular pens,
a toy,
furniture, and
parts for a motor vehicle such as, for example, an airplane, a drone, an aircraft, an electric bicycle, a moped, a motorcycle, a sidecar, a car, a van, a tractor, a truck, a bus, a coach, a snowmobile, a half-track, a bulldozer, a snow groomer and a tank.

In one embodiment, at least 50% by weight of recycled aliphatic polyamide is present in each of the two elements relative to the total weight of the composition of each element.

In other words, the sum by weight of recycled aliphatic polyamide in the first element and of recycled aliphatic polyamide in the second element is at least 50% relative to the total weight of the two compositions of each element.

In another embodiment, the matrix of each of the two elements (fillers and additives excluded) consists of 60% by weight, advantageously 80% by weight, preferably 100% by weight of recycled aliphatic polyamide.

The term “element” denotes each of the things, the combination of which forms another thing, a whole, namely in the present invention a mono-material object.

In particular, an element denotes a component, a constituent, a fragment, a part, a piece or unit which constitutes the mono-material object.

The expression “said first and second elements possibly adhering at least partially to each other” means that said first and second elements may or may not adhere to each other.

In one embodiment, said first and second elements are free of adhesion to each other.

In another embodiment, said first and second elements adhere to each other, at least partially, notably entirely.

The term “adheres” means that said first and second elements are placed one against the other or applied one against the other, at least partially and notably by bonding, clip-fastening, overmolding, thermoforming, screwing, sewing, welding or riveting.

Needless to say, said first and second compositions which comprise a recycled aliphatic polyamide may also comprise additives and, optionally, impact modifiers and/or plasticizers and/or fillers as defined previously.

According to one embodiment, the invention also relates to a process for manufacturing an object using solid particles as defined previously, by remelting said particles and then shaping an object by extrusion, molding or blowing of the melted particles.

The invention is also directed toward protecting an object, in particular a mono-material object, which may be obtained via such a process. It may notably be a mono-material object as defined previously.

According to yet another of its aspects, the invention aims to protect an extruded, molded or blown part, for example an injection molded part, a continuous fiber composite, a film, a fiber, a yarn or a filament.

According to one embodiment, the invention relates to a process for manufacturing a composition as defined previously, comprising at least the following steps:
a) acquiring post-industrial waste and/or post-consumer waste, notably as defined previously,
b) grinding said post-industrial waste and/or said post-consumer waste,
c) optionally, granulating the ground material obtained at the end of step (b),
d) preparing said composition, for example by means of an extruder.

The process for manufacturing a composition of the invention includes at least one step which consists in adding at least one additive as defined previously to the recycled aliphatic polyamide as defined previously.

According to one embodiment, step d) of the manufacturing process described above comprises at least the addition of 0.1% to 10% by weight of additives, relative to the total weight of said composition, notably of 0.3% to 6% by weight, for example of 0.5% to 2% by weight.

According to one embodiment, step d) of the manufacturing process described above comprises at least the mixing of 30% to 99.9% by weight of at least one recycled aliphatic polyamide having functions resulting from oxidation reactions chosen from primary amide functions, nitriles, chain-end methyl groups, alkenes, formamides, imides, carboxylic acids, alcohols and mixtures thereof, in a mole ratio relative to the secondary amide functions greater than that of the same virgin aliphatic polyamide an/or of at least one recycled aliphatic polyamide containing primary amine functions in a mole ratio relative to secondary amide functions lower than that of the same virgin aliphatic polyamide, and from 0.1% to 10% by weight of at least one additive, the contents being expressed by weight relative to the total weight of the composition.

This step may also comprise the additional mixing of 0% to 70% by weight of at least one virgin polyamide, 0% to 65% by weight of at least one filler, 0% to 15% by weight of at least one plasticizer, and/or 0% to 30% by weight of at least one impact modifier.

According to one embodiment, step d) consists in preparing said composition using an extruder, preferably a twin-screw extruder or a co-mixer, to form granules, an extrudate or a powder. Alternatively, a composition of the invention can be manufactured by performing a step of premixing (coarse homogenization) of the solid particles as defined previously before the transformation step. This premixing step is generally carried out at a temperature lower than the melting temperature of said solid particles.

The invention will be explained in greater detail in the examples that follow.

Unless otherwise mentioned, the percentages are expressed hereinafter by weight relative to the total weight of the composition.

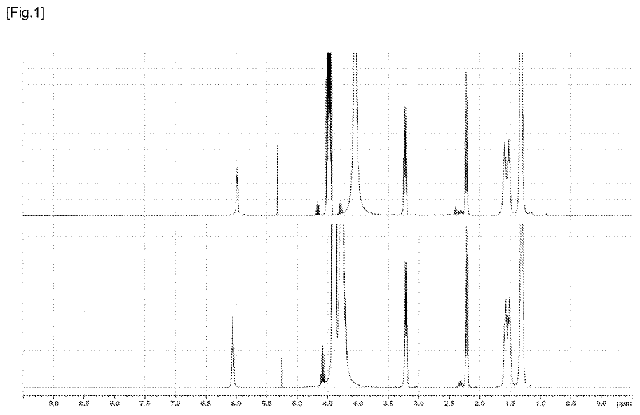

FIG. 1 shows the ¹H NMR spectrum in an HFIP/CD2Cl2 solvent mixture (in an HFIP/CD2Cl2 ratio of 1/3) of PA 1 of the examples (bottom spectrum: virgin PA 1 and top spectrum: recycled PA 1)

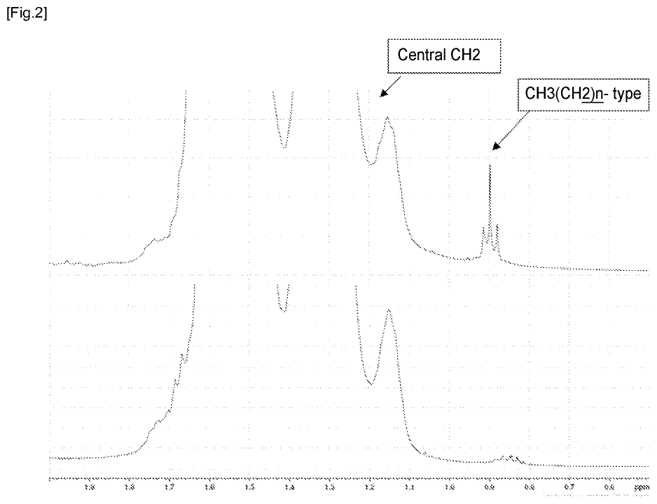

FIG. 2 shows an enlargement of the NMR spectrum of FIG. 1 in the region 2.0 ppm-0.5 ppm (bottom spectrum: virgin PA 1 and top spectrum: recycled PA 1)

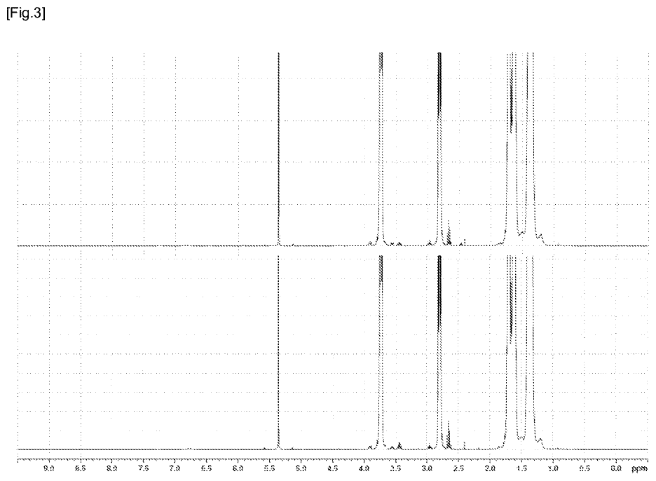

FIG. 3 shows the 1H NMR spectrum in a TFAnh/CD2Cl2 solvent mixture (in a ratio of 100 μl of TFAnh for about 0.6 ml of CD2Cl2) of PA 1 of the examples (bottom spectrum: virgin PA 1 and top spectrum: recycled PA 1)

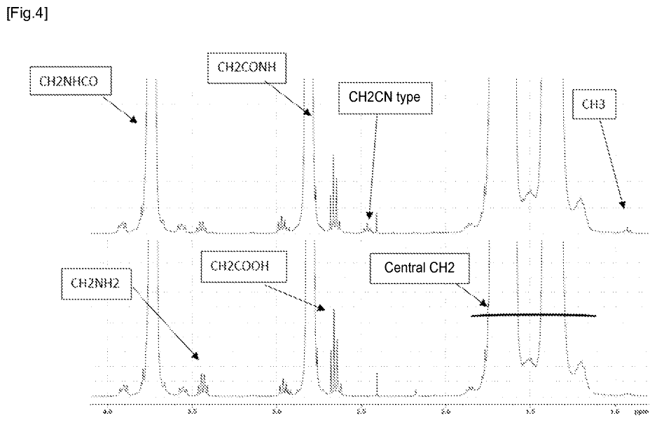

FIG. 4 shows an enlargement of the NMR spectrum of FIG. 3 in the region 4.1 ppm-0.8 ppm (bottom spectrum: virgin PA 1 and top spectrum: recycled PA 1)

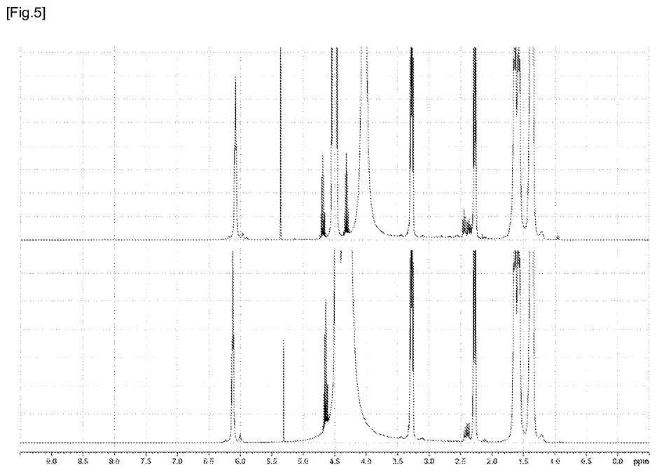

FIG. 5 shows the 1H NMR spectrum in an HFIP/CD2Cl2 solvent mixture (in an HFIP/CD2Cl2 ratio of 1/3) of PA 2 of the examples (bottom spectrum: virgin PA 2 and top spectrum: recycled PA 2)

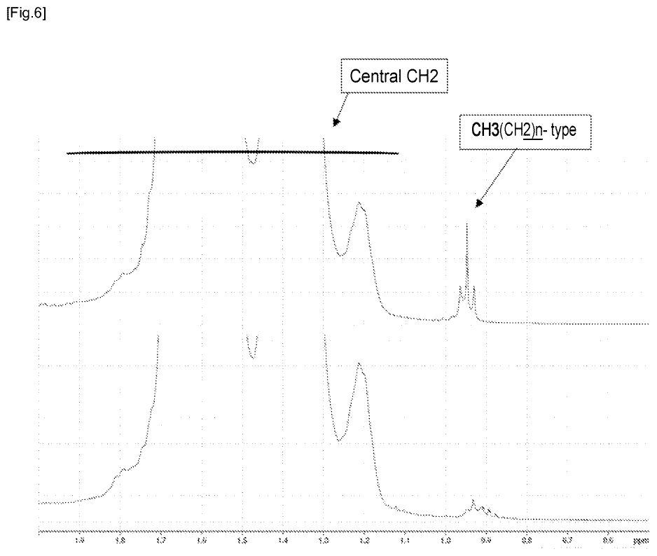

FIG. 6 shows an enlargement of the NMR spectrum of FIG. 5 in the region 2.0 ppm-0.5 ppm (bottom spectrum: virgin PA 2 and top spectrum: recycled PA 2)

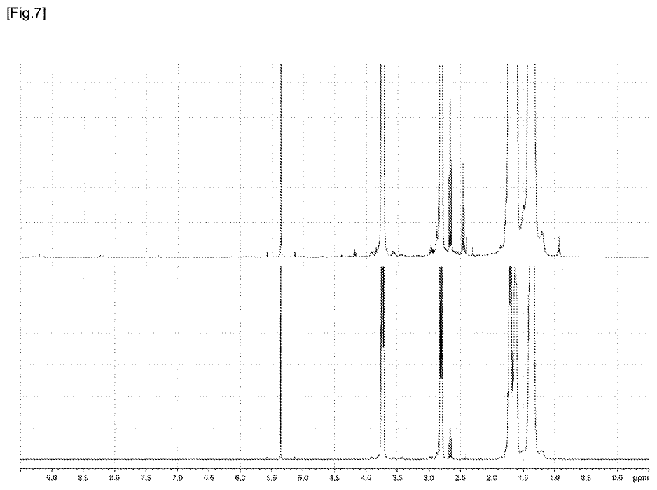

FIG. 7 shows the ¹H NMR spectrum in a TFAnh/CD2Cl2 solvent mixture (100 μl of TFAnh for about 0.6 ml of CD2Cl2) of PA 2 of the examples (bottom spectrum: virgin PA 2 and top spectrum: recycled PA 2)

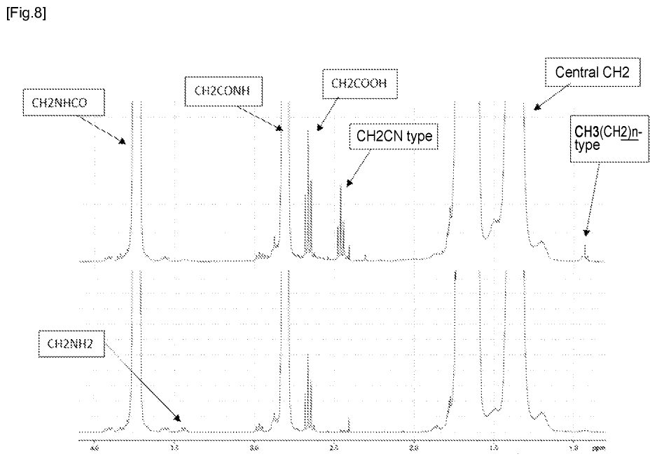

FIG. 8 shows an enlargement of the NMR spectrum of FIG. 7 in the region 4.1 ppm-0.8 ppm (bottom spectrum: virgin PA 2 and top spectrum: recycled PA 2)

### EXAMPLES

PA 1: PA 11 having a number-average molar mass of 36 kg/mol.

PA 2: PA 12 having a number-average molar mass of 30 kg/mol.

The molar masses are measured by size exclusion chromatography (or gel permeation chromatography) according to ISO 16014-1:2012. Molar masses are measured by the refractive index and are expressed in PMMA equivalents, used as a calibration standard, then converted to g/mol.

The mole ratio of the chain-end methyl functions relative to the secondary amides are 0.002 and 0.001 for PA 1 (virgin) and PA 2 (virgin), respectively. The mole ratio of the primary amine functions relative to the secondary amides is 0.009 and 0.004 for PA 1 (virgin) and PA 2 (virgin), respectively. No line corresponding to the nitrile or primary amide groups is observed.

In order to simulate the thermo- or photo-oxidative aging of the PAs during their lifetime, aging in an oven at 140° C. in air for 72 h was performed on PAs 1 and 2. This aging is representative of the degree of oxidation measured on PAs at the end of their life or which have been used several times.

After aging, the mole ratio of the nitrile and chain-end methyl functions relative to the secondary amides is 0.021 and 0.005, respectively, in (recycled) PA 1.

After aging, the mole ratio of the nitrile and chain-end methyl functions relative to the secondary amides is 0.018 and 0.006, respectively, in the (recycled) PA 2.

Only traces of primary amine chain ends are observed (not quantifiable because at too low a concentration).

The aged polyamide according to the invention, IE 1 and IE 2, were then formulated with 0.7% by mass of heat stabilizer (0.5% Lowinox 44B25 (SI Group) and 0.2% Irgafos 168 (BASF)).

Formulation takes place using an 18 mm twin-screw extruder at a flow rate of 5 kg/h and a temperature of 250° C. so as to obtain granules for evaluating the properties obtained during the second life of the material.

The injection flow length was measured on an ENGEL VICTORY 500, 160T injection-molding machine equipped with a spiral mold (spiral flow test), with the following parameters:
Mold temperature: 40° C.
Material hold pressure: 900 bar
Temperature profile for PA 1: 230/250° C.
Temperature profile for PA 2: 220/240° C.
Flow rate: 57 cm³/s
Cooling time: 20 s

The test is performed by injecting the molten polymer through the central core which directly feeds the spiral 20 mm wide, 2 mm thick and having a maximum length of 1280 mm. There is a 10 mm space between the channel walls of the spiral. The spiral mold is mirror polished.

The flow length values reported in the table below are the average of the ten tests performed for each sample.

This measurement characterizes the processability of the compositions.

TABLE 1

| | | IE1 aged PA 2 |
|---|---|---|
| | CE1 virgin | (recycled and |
| References | PA 2 | formulated) |
| Percentage elongation | 450.6 | 394 |
| at break | | |
| Flow length (mm) | 695.9 | 875.8 |

The composition IE 1 according to the invention has a flow length significantly greater than that of the comparative composition CE 1.

This means that the composition IE 1 according to the invention exhibits better processability than the comparative composition CE 1.

In particular, it will advantageously be possible to injection mold finer parts and/or parts with better definition using a composition IE 1 according to the invention.

It can also be observed that the elongation at break of the composition according to the invention is lower than that of the comparative composition, but the value obtained is satisfactory for a large number of applications.

The compositions according to the invention make it possible to obtain a new tradeoff between processability and mechanical properties.

TABLE 2

| | | IE2 aged |
|---|---|---|
| | CE2 PA 1 | (recycled and |
| References | (virgin) | formulated) PA 1 |
| Percentage elongation | 341.6 | 235.4 |
| at break | | |
| Flow length (mm) | 351.5 | 426.0 |

The composition IE 2 according to the invention has a flow length significantly greater than that of the comparative composition EC 2.

This means that the composition IE 2 according to the invention exhibits better processability than the comparative composition CE 2.

In particular, it will advantageously be possible to injection mold finer parts and/or parts with better definition using a composition IE 2 according to the invention.

It can also be observed that the elongation at break of the composition according to the invention is lower than that of the comparative composition, but the value obtained is satisfactory for a large number of applications.

The compositions according to the invention make it possible to obtain a new tradeoff between processability and mechanical properties.

1. A composition comprising at least:
(a) from 30% to 99.9% by weight of at least one recycled aliphatic polyamide having functions resulting from oxidation reactions chosen from primary amide functions, nitriles, chain-end methyl groups, alkenes, formamides, imides, carboxylic acids, alcohols and mixtures thereof in a mole ratio, relative to the secondary amide functions, which is greater than that of the same virgin aliphatic polyamide and/or of at least one recycled aliphatic polyamide having primary amine functions in a mole ratio, relative to the secondary amide functions, which is lower than that of the same virgin aliphatic polyamide,
(b) from 0.1% to 10% by weight of at least one additive,
(c) from 0% to 70% by weight of at least one virgin polyamide,
(d) from 0% to 65% by weight of at least one filler,
(e) from 0% to 15% by weight of at least one plasticizer,
(f) from 0% to 30% by weight of at least one impact modifier.

2. The composition as claimed in claim 1, wherein said mole ratio of functions resulting from oxidation reactions relative to the secondary amide functions is between 0.0005 and 0.3.

3. The composition as claimed in claim 1, wherein said mole ratio of imide functions relative to the secondary amide functions is between 0.0005 and 0.1.

4. The composition as claimed in claim 1, wherein said mole ratio of carboxylic acid functions relative to the secondary amide functions is between 0.0005 and 0.1.

5. The composition as claimed in claim 1, wherein said mole ratio of alcohol functions relative to the secondary amide functions is between 0.0005 and 0.1.

6. The composition as claimed in claim 1, wherein said mole ratio of primary amide functions relative to the secondary amide functions is between 0.0005 and 0.1.

7. The composition as claimed in claim 1, wherein said mole ratio of nitrile functions relative to the secondary amide functions is between 0.0005 and 0.1.

8. The composition as claimed in claim 1, wherein said mole ratio of chain-end methyl functions relative to the secondary amide functions is between 0.0005 and 0.2.

9. The composition as claimed in claim 1, comprising:
(a) from 30% to 99.9% by weight of at least one recycled aliphatic polyamide having functions resulting from oxidation reactions chosen from primary amide functions, nitriles, chain-end methyl groups, alkenes, formamides, imides, carboxylic acids, alcohols and mixtures thereof in a mole ratio, relative to the secondary amide functions, which is greater than that of the same virgin aliphatic polyamide and/or of at least one recycled aliphatic polyamide having primary amine functions in a mole ratio, relative to the secondary amide functions, which is lower than that of the same virgin aliphatic polyamide,
(b) from 0.1% to 10% by weight of at least one additive,
(c) from 0% to 70% by weight of at least one virgin polyamide,
(d) from 0% to 65% by weight of at least one filler,
(e) from 0% to 15% by weight of at least one plasticizer, and
(f) from 0% to 30% by weight of at least one impact modifier.
the sum of the constituents (a)-(f) being equal to 100%.

10. The composition as claimed in claim 1, wherein said aliphatic polyamide has a C/N ratio of greater than 6.5.

11. The composition as claimed in claim 1, wherein said aliphatic polyamide is obtained by polycondensation:
of at least one C₉ to C₁₈ amino acid, or
of at least one C₉ to C₁₈ lactam, or of at least one aliphatic diamine Ca or of at least one C₄-C₃₆ diamine Ca with at least one C₄-C₃₆ dicarboxylic acid Cb, or a mixture thereof.

12. The composition as claimed in claim 1, wherein said aliphatic polyamide is obtained by polycondensation:
of at least one C₉ to C₁₈ amino acid, or
of at least one C to C₁₈ lactam.

13. The composition as claimed in claim 1, wherein said aliphatic polyamide is chosen from polyamide 410 (PA410), polyamide 510 (PA510), polyamide 610 (PA610), polyamide 612 (PA612), polyamide 1010 (PA1010), polyamide 1012 (PA1012), polyamide 1212 (PA1212), polyamide 11 (PA11), polyamide 12 (PA12), or a blend thereof or a copolyamide thereof.

14. The composition as claimed in claim 1, wherein it comprises from 0.1% to 50% by weight of at least one virgin polyamide, relative to the total weight of the composition.

15. The composition as claimed in claim 1, wherein said additive is chosen from a catalyst, an antioxidant, a heat stabilizer, a UV absorber, a light stabilizer, a lubricant, a nucleating agent, a dye, a wax and mixtures thereof.

16. The composition as claimed in claim 1, wherein it is in the form of solid particles with a median diameter D50 of less than 20 mm.

17. A method of using 30% to 99.9% by weight of at least one recycled aliphatic polyamide in a composition as claimed in claim 1, to give said composition a longer injection flow length relative to the same composition in which the aliphatic polyamide is not recycled.

18. A method comprising using a composition as claimed in claim 1 for manufacturing objects.

19. An object consisting of at least 30% by weight of a composition as claimed in claim 1.

20. A process for manufacturing an object using solid particles as defined in claim 16, by remelting said particles and then shaping an object by extrusion, molding or blowing of the melted particles.

21. An object which may be obtained via the process of claim 20.

22. The object as claimed in claim 21, wherein it is an extruded, molded or blown part, for example an injection moulded part, a continuous fiber composite, a film, a fiber, a yarn or a filament.

23. A process for manufacturing a composition as defined according to claim 1, comprising at least the following steps:
a) acquiring post-industrial waste and/or post-consumer waste,
b) grinding said post-industrial waste and/or said post-consumer waste,
c) optionally, granulating the ground material obtained at the end of step (b),
d) preparing said composition, for example by means of an extruder.
